(19) United States
(12) Patent Application Publication
(10) Pub. No.: US 2004/0128295 A1
(43) Pub. Date: Jul. 1, 2004

(54) Data structure depicting an event for use in a computer implemented situation manager and method and system for use therewith

(75) Inventors: Asaf Adi, Kiryat Ata (IL); David Botzer, Haifa (IL); Opher Etzion, Haifa (IL); Tali Yatzkar-Haham, Misgav (IL)

Correspondence Address: Stephen C. Kaufman, Intellectual Property Law Dept., IBM Corporation, P.O. Box 218, Yorktown Heights, NY, 10598, US

(73) Assignee: International Business Machines Corporation, Armonk, NY

(21) Appl. No.: 10/331,449

(22) Filed: Dec. 27, 2002

(51) Int. Cl. G06F 7/00

(52) U.S. Cl. 707/100

(57) ABSTRACT

For use with a computer implemented situation manager a data structure for depicting events contains data representative of an event model defining a hierarchy of events and inter-relationships between events so as to allow a lower order event to be defined from a higher order event having similar characteristics. The event model allows a system designer to separate the knowledge about the events from the situations' definition resulting in a clear event diagram to be defined that illustrates the event connections, instead of concealing this knowledge inside the situations' definition. As a result, there is no need to implement the event connections using situations. This reduces the number of the defined situations, simplifies the situations themselves and improves run time performance.

### FIELD OF THE INVENTION

This invention relates to event-driven systems.

### REFERENCES

Reactive Applications:

[1] P. Osmon and P. Sleat: IDRIS: “Interactive Design of Reactive Information Systems”. CAiSE 1992: 494-506.

[2] D. Tombros, A. Geppert, and K. R. Dittrich: “Semantics of Reactive Components in Event-Driven Workflow Execution”. CAiSE 1997: 409-422.

UML:

[3] C. Kobryn: UML 2001: “A Standardization Odyssey”. CACM 42(10): 29-37, 1999.

Workflow Modeling:

[4] O. Etzion, A. Gal—“CODES—a design tool for computerized systems”. Proceed 2^{nd} International Workshop on Next Generation Information Technologies and Systems, Naharia, June 1995, pp. 116-123.

[5] O. Etzion—Kerem—“Reasoning about partially cooperative systems”. In Dogac et al. (eds)—Workflow Management Systems and Interoperability, Springer-Verlag, November 1998.

Composite Events:

Several previous proposals of composite events allow some functionality of looking at an event that is composed of several events. References to these models are:

[6] S. Chakravarthy & D. Mishra—“Snoop: an expressive event specification language for active databases”. Data & Knowledge Engineering, 13(3), October 1994.

[7] N. H. Gehani, H. V. Jagadish, O. Shmueli—“Composite event model specification in active databases: model and implementation”. Proceedings VLDB'92.

[8] S. Gatziu, K. Dittrich—“Detecting composite events in active database systems using Petri Nets”. Proceedings IEEE RIDE'94.

[9] D. Zimmer, R. Unland, A. Meckenstock—“A General model for event specification in active database management systems”. In Proceeding 5th DOOD, 1997.

[10] C. Collet, T. Coupaye, T. Svenson—“NAOS—Efficient and modular reactive capabilities in an object-oriented database system”. In Proceedings. VLDB'94.

[11] G. Kappel, S. Rausch-Schott, W. Retschitzegger—“A Tour on the TriGS active database system—architecture and implementation”. Proceedings ACM SAC'98.

Semantic Models:

[12] J. M. Smith and D. C. P. Smith: “Database Abstractions: Aggregation and Generalization”. TODS 2(2): 105-133, 1977.

[13] M. L. Brodie and D. Ridjanovic: “On the Design and Specification Database Transactions. On Conceptual Modeling”, Springer-Verlag 1984: 277-312.

[14] J. Peckham and F. J. Maryanski: “Semantic Data Models. Computing Surveys” 20(3): 153-189, 1988.

### BACKGROUND OF THE INVENTION

Reactive applications are those that react to the occurrence of events by the activation of alerts or actions. In contemporary systems there are an increasing number of reactive components that are used for many application types such as: E-Commerce applications (auctions, stocks trading alerts), system management, customer relationship monitoring control systems and publish/subscribe systems.

Current tools for application modeling do not provide any capability to focus on the event semantics and relationships to other entities (e.g. events). While the concept of events exists in modeling tools such as United Modeling Language (UML), the modeling power is limited to interactions of event and state changes. Both United Modeling Language and UML are trademarks of Object Management Group (OMG), a consortium headquartered in Needham, Mass., USA of which the present applicant is a member, and that produces and maintains computer industry specifications for interoperable enterprise applications. There have been references to events as first class modeling entities in the workflow modeling area, but these works did not provide an event modeling system.

U.S. Pat. No. 6,208,720 (Curtis et al.) published Mar. 27, 2001 and entitled “System, method and computer program product for a dynamic rules-based threshold engine” discloses a configurable and scalable rules-based thresholding system, method and computer program product for processing event records having a core infrastructure and a configurable domain-specific implementation. The core infrastructure is generically employed regardless of the actual type of network being monitored. The domain-specific implementation is provided with user specific data and rules. The core infrastructure includes an event record enhancer which enhances events with additional data and a threshold detector which determines whether an enhanced event record, alone or in light of prior event records, exceeds one or more thresholds. The enhancer can access external databases for additional information related to an event record. In one embodiment, the enhancer generates feature vectors to represent enhanced event records. The threshold detector receives enhanced event records from the event record enhancer. The threshold detector selects one or more threshold rules from a database of threshold rules for applying to the enhanced event records. Where enhanced event records are in the form of feature vectors containing features and feature values, the threshold detector selects one or more threshold rules based upon the features or feature values in the vector. Where the feature vector includes a threshold for a feature value, the threshold detector tests the feature values against the threshold. The threshold detector may access prior event records in order to apply one or more threshold rules.

U.S. Pat. No. 6,006,016 (Faigon et al.) published Dec. 21, 1999 and entitled “Network fault correlation” discloses a method and apparatus for correlating faults in a networking system. A database of fault rules is maintained along with and associated probable causes, and possible solutions for determining the occurrence of faults defined by the fault rules. The fault rules include a fault identifier, an occurrence threshold specifying a minimum number of occurrences of fault events in the networking system in order to identify the fault, and a time threshold in which the occurrences of the fault events must occur in order to correlate the fault. Occurrences of fault events in the networking system are detected and correlated by determining matched fault rules which match the fault events and generating a fault report upon determining that a number of occurrences for the matched fault rules within the time threshold is greater than or equal to the occurrence threshold for the matched fault rules.

U.S. Pat. No. 5,748,098 (Grace) published May 5, 1998 and entitled “Event correlation” discloses a system where simultaneous events reported to an equipment management system are compared with historical data in order to establish whether there is a relationship between the events. Historical data is used to determine the probability of the events occurring independently simultaneously. If this probability is below a predetermined threshold this will suggest that the events are not independent, but are relaxed. Such relationships are alerted to an operator, for example by highlighting or grouping on a screen display, assisting the operator in identification of related events, without the need for prior knowledge of the relationships in the system. The events may be alarms generated by faults in a network. The identification of related faults at different points in the network assists identification of their common cause. The historical database may be updated by further event occurrences as they are reported to the equipment management system, thereby enlarging the database to make the results more statistically accurate. Events may be reported to the system automatically or by human agency. To allow for systematic delays in event reporting, alarms from one source may be compared with alarms from another source occurring a fixed time later or earlier.

Thus, the prior art teaches identification of events in the networking world, possibly using historical data. It does not define an event correlation language, or refer to event context. Nor it does support an event model.

U.S. patent application Ser. No. 10/131,232 entitled “Method and system for ensuring system awareness with database connection on demand” filed Apr. 25, 2002 and assigned to the present assignee describes a method for establishing a situation for use in an event-driven application. Events are integrated with auxiliary data queried from an external database for generating a composite event defining a situation.

A drawback with known approaches is the inefficiency of both the design phase and the run-time execution owing to the lack of support in “built-in” types of relationships among events, and between events and other entities. Specifically, known tools require situations to be modeled in order to cover all possible events relations. In practice this requires the definition of multiple situations, resulting in the need for high computer resources such as processing time and memory.

It would therefore be desirable to provide a computer-implemented tool for modeling event-driven systems that allows for a simpler definition of situations and saves on computer resources resulting in improved run-time performance.

### SUMMARY OF THE INVENTION

It is an object of the invention to provide the system designer with a tool that will enable the rule set to be substantially reduced, thus improving both the development time efficiency and the run-time performance.

There are two main issues with which the invention is concerned:

1. What is the model that captures these relationships among events with regard to the rules the events refer to? Thus, this aspect of the invention relates to the need to develop a hierarchical relationship between events that allows events to be linked so that rules belonging to or associated with multiple events having the same class do not have to be defined for each event separately, but rather can be defined for the class and thus inherited by all events of that class.

2. How can the use of this abstraction inject efficiency in reactive systems?

The object of the invention is realized in accordance with a first aspect by a data structure depicting events for use in a computer implemented situation manager, said data structure comprising an event model defining a hierarchy of events and inter-relationships between events in said hierarchy so as to allow a lower order event to be defined from a higher order event having similar characteristics.

A method for establishing a situation using such a data structure depicting an event or situation comprises:

(a) pre-configuring before runtime an event model defining an inter-relationship between events that may participate in said situation under defined conditions,

(b) pre-defining before runtime one or more situations that may occur depending on an occurrence of one or more events in the event model and depending on predetermined conditions,

(c) determining on runtime, according to an incoming event and its event definition, all the reference events that need to be generated, and

(d) generating on runtime from the incoming events, the referenced events and conditions all situations that occur.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a diagram showing an event model of event class relationships useful for explaining concepts associated with the invention;

FIG. 2 is a pictorial diagram showing simple entity relationships in the event model of FIG. 1;

FIGS. 3, 4 and 5 are tables demonstrating some scenarios (and their detected situations) related with the event model of FIG. 1;

FIGS. 6a and 6b is a table showing situations that are defined in a possible prior art implementation for identifying specified situations in a brokerage system;

FIG. 7 shows pictorially an event model depicting all events relating to organization activity in the brokerage system;

FIG. 8 is a table showing a possible implementation for defining the required situations using the event model of FIG. 7 for implementing the specified situations in the brokerage system;

FIG. 9 is a flow diagram showing the principal operations carried out by a situation manager according to the invention; and

FIG. 10 is a block diagram showing functionally a system for carrying out the invention.

### DETAILED DESCRIPTION OF THE INVENTION

### Event Model and with Implications on Situation Manager

### Semantic Abstractions

The area of semantic data modeling has provided a substantial contribution to the conceptualization and to the functionality of data models. Before describing a preferred embodiment, the semantic abstractions will first be briefly surveyed, and their relevance to the event management domain shown.

Classification: This abstraction classifies an event to an event class, i.e. a set of events with similar characteristics. This is a fundamental abstraction, which is known in the art per se and allows defining operations on events in the class level. A single event is considered to be a member of a single class, denoted by:

classified-to (e, E), instance-of is a predicate with two arguments: an event-class and an event. If instance-of (E, e) is evaluated to true, then all the functionality associated with E applies for e. The classification rule states:

classified-to (e, E)→instance-of (E, e).

According to the classification rule, instance-of (E, e) is evaluated to true, for each event e that has been classified to E. In the following description there will be discussed additional ways in which an event e can behave as if it is an instance of E, besides direct classification.

Aggregation: This semantic abstraction is also known in the art per se. However, most of the existing event models view an event as an atomic unstructured entity. The invention employs an aggregation abstraction that views an event as a set of attributes, each of them with a value specific to this event. The attributes are defined at the class level, where the instances of these attributes are considered as a part of the event values. Attributes may have different types such as: numeric, string and references to objects and events. The supported data structure should be flexible and include atomic attributes, sequence and set attributes, and tuple attributes.

The following semantic abstractions are specific to the invention:

Additional Classification: The classified-to function classifies an event into a unique event class. There are several cases in which it is desirable to act in certain contexts as if an event is classified into additional classes. These cases are strict generalization, conditional generalization and association.

Strict Generalization: A generalization is a subset hierarchy relationship between two event classes, denoted by a function generalized-to (E, {E1 . . . , En}). It means that each of the elements in the set {E1, . . . , En} is a generalization of E, i.e. multiple generalizations are permitted.

This rule can be applied in a recursive way, e.g. if e is classified to E, that is generalized to E′, while E′ is generalized to E″, then according to the generalization rule, e is an instance of E′ and E″ in addition to E. This strict generalization abstraction is common in systems, and is equivalent to strict inheritance in object-oriented models.

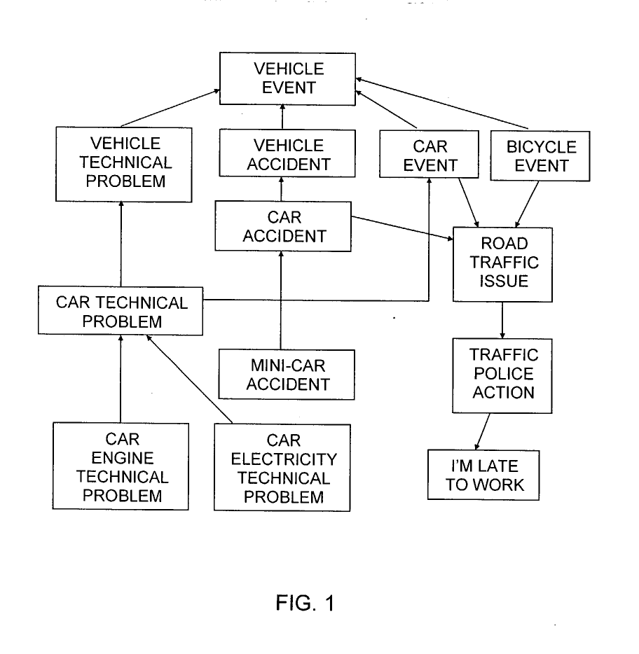

FIG. 1 is a diagram showing an event hierarchy of event class relationships. The event-classes have various inter-relationships as depicted by an arrow pointing from one event to another dependent event. Thus, an event A pointing to an event B denotes that there is a relationship between class-event A and class-event B. In the following description, the event A will be referred to as a lower order event and the event B will be referred to as a higher order event. The event hierarchy defines a general event called “vehicle event” pointed to by events “vehicle technical problem”, “vehicle accident”, “car event” and “bicycle event”. Put simply, this means that “vehicle technical problem”, “vehicle accident”, “car event” and “bicycle event” are all instances of the “vehicle event” class.

It will be assumed that each event instance (of each event-class) can trigger a rule (or some rules). For example: the event “car accident” may trigger a rule—“Automatic alarm to traffic control center” (not shown in the figure). Owing to the class hierarchy, an instance from one event-class may trigger a rule that is defined to be triggered by another event-class. Thus, it is seen that “mini-car accident” is an instance of the “car accident” event class. So, regardless of any specific rule that may possibly be associated with the “mini-car accident” event, an occurrence of the “mini-car accident” event may cause the rule “Automatic alarm to traffic control center” associated with the higher order event “car accident” also to be invoked.

Likewise, it will be noted that “car accident”, “car event” and “bicycle event” all give rise to the event “road traffic issue”, which in turn gives rise to the event “traffic police station” and “I'm late to work”. The events “traffic police station” and “I'm late to work” are therefore both invoked if any of “car accident”, “car event” and “bicycle event” occurs. Consequently, any rules associated with “traffic police station” and “I'm late to work” may be available for “car accident”, “car event” and “bicycle event” and so do not need to be defined separately for each of these events. Note that we say that rules associated with a higher order event may be available, rather than are available, for lower order events since conditions may be applied that prevent this. Such an event model allows a complex set of rules to be associated with multiple inter-related events much more efficiently than could be done by defining rules for each event separately as is done in hitherto-proposed event models.

### EXAMPLE

The event-class “mini-car accident” can be generalized to “car accident”, and the event-class “car accident” can be generalized to “vehicle accident”.

Conditional Generalization: A conditional generalization is a generalization that is contingent upon additional conditions. Known data models support only strict generalization; conditional generalization is a novel feature of the invention. The types of conditions can be attribute values and context variables.

### EXAMPLES

1. The event-class “HP Printer Failure” is generalized to “HP Product Problem”, only if the attribute failure-type=“unrecoverable”. In this case an event e which is classified to “HP Printer Failure” is considered as an instance of the event-class “HP Products Problem” only if its failure-type is equal to “unrecoverable”.

2. The event-class “HP Printer Failure” is generalized to “HP Product problem”, only in the context of the situation “alert on more than 3 HP related problems per day”, and not in any other context. A condition can also be a conjunction or disjunction of both types.

It should be noted that conditional generalization does not exist in data models, because generalization of objects denotes a strict subset hierarchy. In the event world, the classification to higher order does not necessarily imply subset hierarchy; it can imply events that have the same operational semantics in certain cases. This additional classification may be context-sensitive and not strict.

Cross-section association: A cross-section association is a relationship between two classes and a conditional expression, denoted as Cross-section association-of (E, E′, COND). This relationship denotes that E′ is a cross-section association of E, under the condition COND. The association relationship creates an additional virtual event class, to which there are no events that are directly classified.

Example: the event class is “Printer Failure”, the condition is “Time between 8:00 am and 5:00 pm”, and the association is: “Printer Failure during working hours”.

Uncertain Generalization/cross-section association: A generalization or an association relationship may have some certainty value, which designates the strength of this relationship. The exact interpretation of this value is not a feature of the present invention and so is not discussed further.

### The Event Model

Every event belongs to a unique event class. Connections between the event classes enable events to be classified to additional classes. The connection types are:

Generalization—a subset hierarchy relationship between two event classes.

### EXAMPLE

The event-class “mini-car accident” can be generalized to “car accident”, and the event-class “car accident” can be generalized to “vehicle accident”.

Cross-section Association—a relationship between two classes and a conditional expression. The cross-section relationship creates an additional virtual event class. No events are directly classified to this additional virtual event class.

Influence—a situation where one event class influences an event from other class.

Depend-on—a situation where one event class depends on events from other event classes.

An event may have a set of reference events in order to support relationships and dependencies between event classes. At runtime, the situation manager creates a reference event based on the incoming event references. A reference event includes the following features:

Name of the reference event.

Reference connection type (i.e., generalized/cross-section/influenceOn/dependOn).

Condition under which the reference connection occurs.

Certainty value for the reference connection (assuming that the condition is evaluated as true).

### Knowledge Representation Scheme

Each event has the following scheme:

The Basic Schema:

Attributes set: A set of attributes that are aggregated to each event instance.

Temporal dimensions: Event occurrence time, event detection time.

The Semantic Event Model Attributes:

Generalization_Set: Set of generalized events.

An element in this set is composed of:

Gener_event: An event-class id.

Gener_Cond: The conditional expression that if evaluated to “true”, the event is generalized (the default is “true” to denote strict generalization).

Gener_Certainty: The certainty value associated with the generalization operation.

Association_Set: Set of cross_section_associated events.

An element in this set is composed of:

Assoc_event: An event-class id.

Assoc_Cond: The conditional expression that if evaluated to true, the event is associated.

Assoc_Certainty: The certainty value of the association operation.

The same structures are defined for Influence_Set and Depend_On_Set.

### The Situation Manager Attributes

Situations_Set: set of related events (situations) that an instance of ei participates in their composition (detection).

### The Reactive Attributes

Reaction_Set: set of conditions and actions.

### The Model Properties

The Properties Are:

1. Generalization and Cross-Section Association

The attributes: Generalization_Set and Cross_section_Association_Set include all the events directly generalized from an event and all the events associated with the event, respectively.

### EXAMPLE

Laser-printer-error. Generalization_Set. Gener_event={printer-error}

Printer-error. Generalization_Set.Gener_event={peripheral-device-error, device-error, floor4-device-error}

Laser-printer-error.Association_Set.Assoc_event={HP-Laser-printer-error, Canon-Laser-printer-error}.

2. Condition

The attributes Gener_Cond and Assoc_Cond represent the conditional expression in which this event is generalized or associated to the Gener_event and Assoc_event, respectively.

The strict generalization case is a special case, in which Gener_Cond=“TRUE”, another trivial (and useless) case is that that the value of Gener_Cond=“FALSE”.

In a similar way, we can assign “TRUE” or “FALSE” values to Assoc_Cond.

3. Certainty

The attributes Gener_Certainty and Assoc_Certainty represent the certainties with which this event is generalized or associated with the Generalization_event and Association_event, respectively.

Special cases are:

Gener_Certainty=1 (the default case), and

Gener_Certainty=0 (again, useless case).

In a similar way, Assoc_Certainty can be assigned values of 1 or 0.

4. Situations

The attributes: Special_SC_Cond/Certainty (SC=Situation Context).

Let events' class E1 be a generalization of events' class E11, and S1 be a situation for which E1 is a participating event. Let e be an event that is classified to E11. The condition/certainty that are defined on (E1, S1) determines whether e participates in the evaluation of S1 in the role of E1.

In another words, this attribute enables the situation manager user/designer to control (or to filter) the generalization and the association relationships for any specific situation context's point of view. Note that the condition may refer to the original event class of an event using the predicate instance-of.

A situation is a special case of an event; thus, we can define generalization and association relationships among situations, as well. A situation that participates in another situation (like an event) is handled the same as an event handling. This is an additional way to define relationships among situations even if there are no relationships among their events.

### EXAMPLE

### Generalization & Cross-Section Association

Consider four events that are defined as follows:

E1, E11, E111, E12—events' classes.

Events: e1 ∈ E1, e11 ∈ E11, e111 ∈ E111, e12 ∈ E12

Example:

e1=“printer-error”

e11=“Laser-printer-error”

e111=“HP-Laser-printer-error”.

e12=“Printer Failure during working hours”

Property #1:

E11.Generalization_Set={E1}

E111.Generalization_Set={E11}

E1.Association_Set={E12}.

Suppose E2, E3 are events' classes too, when the appropriate events are e2 ∈ E2, e3 ∈ E3.

There are the following situations:

S1=sequence (E2, E3, E1)

S11=sequence (E2, E3, E11)

S111=sequence (E2, E3, E111)

S12=sequence (E2, E3, E12)

“sequence” is an operator that is satisfied if instances of its arguments occur in the specified order.

The events e2∈E2, e3∈E3 have already occurred, and a new event occurs now.

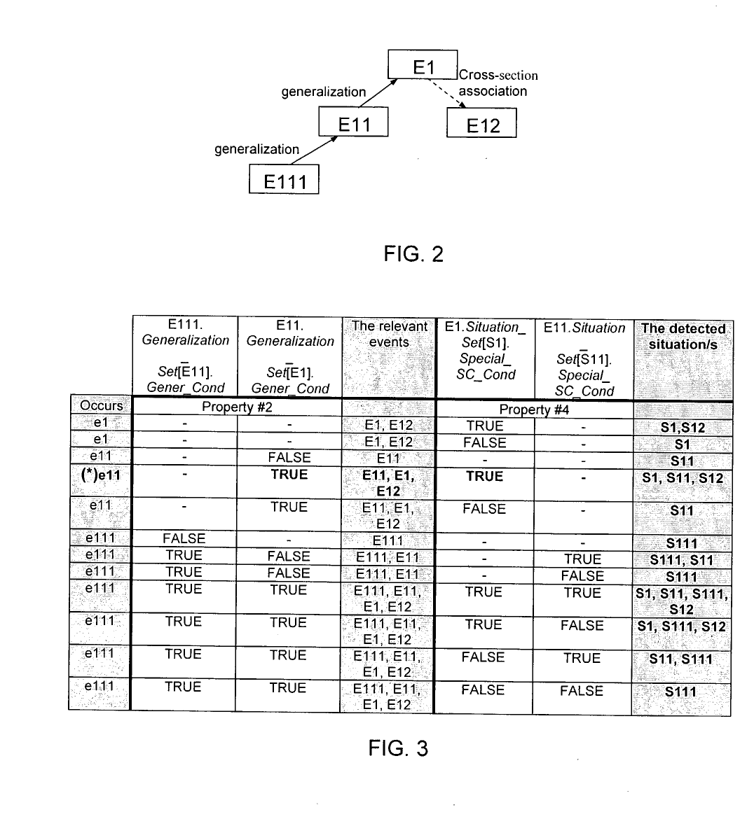

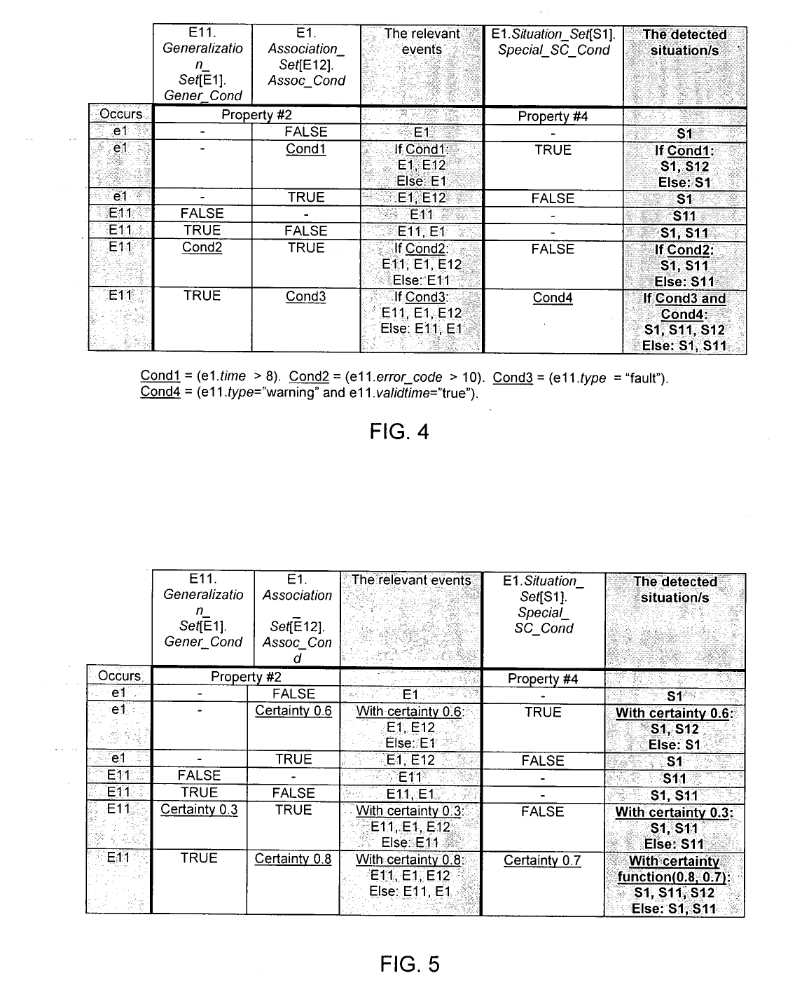

FIG. 2 is a pictorial diagram showing simple entity relationships in the event model of FIG. 1. FIGS. 3, 4 and 5 showing respectively tables 1, 2 and 3 demonstrate some scenarios (and their detected situations) related with the example. The notation (−) in all the Tables indicates that the designated column is irrelevant.

In Table 1:

Property #2: E1.Association_Set[E12].Assoc_Cond=TRUE, for all the scenarios in Table 1.

For example consider the case marked as (*). Event e11 occurs. It is seen from FIG. 2 that the generalization condition of E11 with respect to E1 is TRUE. As a result E1 is also a relevant (class) event. It is also seen from FIG. 2 that the association condition of E1 respect to E12 is TRUE (for all cases). As a result E12 is also a relevant (class) event.

So, the relevant events are: E11, E1, E12.

Situation S11 will be detected because s11 is a strict function of E11 (with no conditions).

S12 will be detected because E12 participate in S12.

E1's Special_SC_Cond (specialized situation context) is TRUE with respect to situation S1, so situation S1 will be detected.

As a result, the detected situations will be: S1, S11, S12.

In Table 2:

Some of the TRUE/FALSE values in table 1 are replaced by conditions. Not all possible cases are described in Table 2. Thus, only if the condition of a lower order event is fulfilled, i.e. TRUE does the higher order event occur upon occurrence of the associated lower order event. Otherwise, the higher order event does not occur upon occurrence of the associated lower order event.

In Table 3: The certainty in property #3 (certainty) is treated in similar way: The certainty function is a function that maps n certainty values to one representative value.

### EXAMPLES

f(c1, c2)=c1+c2−(c1*c2)

f(c1, c2)=min(c1, c2)

f(c1, c2)=max(c1, c2)

The Algorithm for Generalization/Cross-Section Association

The following algorithm specifies the handling of an incoming event's instance according to the generalization/cross-section events' relationships (phase #1) and how to manage the relevant accepted events according to their contexts/situations (phase #2).

The algorithm employs the conditions and certainties attributes as part of the regular creation of the set of handling the events (“Events_handling_set”) and the detection of the situations.

Phase #1—Creating the Events Handling Set

1. New instance of Event ei arrives

2. Get Event ei Definition.

3. Events_handling_set={ei}

4. repeat

a. for each e in the Events_handling_set do:

for each element j in e.Generalized_Set do:

event ej=e.Generalized_set[j].Generalized_event do

evaluate (e.Generalized_set[j].Generalized_condition)

if TRUE

Generate a certainty mechanism with certainty value

(e. generalized_set[j].generalized_Certainty)

if SUCCESS

add ej to Events_handling_set.

b. event ej=e.Associated_set[j].Associated_event do

evaluate (e.Associated_set[j].Associated_condition)

if TRUE

Generate a certainty mechanism with certainty value

(e. associated_set[j].associated_Certainty)

if SUCCESS

add ej to Events_handling_set.

5. Until no elements were added to Events_handling_{'}set.

The output of Phase #1 is the relevant events set derived from event ei, depending on the semantic event model only, with no consideration of the participation of these events in the situations.

Phase #2—Finding the Relevant Situations

1. For each e in the Events_handling_set do:

Events_Situations_handling_set={ }.

for each element I in e.Situation_set do:

Situation S=e.Situation_set[I].Situation_event.

evaluate (e. Situation_set[I].Specialized_sc_condition)

if TRUE

Generate a certainty mechanism with certainty value

(e. Situation_set[I].Specialized_sc_Certainty)

if SUCCESS

add (e,S) to the Events_Situations_handling_set.

Detection Process

for each element (e,S) in the Events_Situations_handling_set, perform:

Detection process.

Remark: The algorithm does not restrict the inheritance graph topology to a tree. In other words, the algorithm handles multiple inheritances as well as regular inheritances.

Invention Properties

Property Number 1: An Event Model, which Includes Various Relationships Among Events

Every event belongs to a unique event class. Connections between the event classes enable to classify events to additional classes. The connection types are:

Generalization—a subset hierarchy relationship between two event classes.

Cross-section Association—a relationship between two classes and a conditional expression. The cross-section relationship creates an additional virtual event class. No events are directly classified to this additional virtual event class.

Influence—a situation where one event class influences an event from other class.

Depends-on—a situation where one event class depends on events from other event classes.

An event may have a set of reference events in order to support relationships and dependencies between event classes. At runtime, the situation manager creates a reference event based on the incoming event references. A reference event includes the following features:

Name of the reference event.

Reference connection type (i.e., generalized/cross-section/influenceOn/dependsOn).

Condition under which the reference connection occurs.

Certainty value for the reference connection (assuming that the condition is evaluated as true).

Property Number 2—Integration of the Event Model into a General Rule Engine and into a Special Multi-Event Correlation Engine—the Situation Manager

Two main features:

Definition of rules with the presence of the event model.

Distinction according to the event source.

Every event instance has a set of built-in attributes in addition to its defined attributes.

The built-in attributes are:

Event source—possible values are:

Basic Event—the event was pushed into the situation manager by an external source.

Situation—an instance that was created by the situation manager as a result of situation detection.

Secondary_Influenced—an instance that was created by the system as an influenced instance of a dependent instance of a basic (external) event.

For example, a “printer_error” depends on an “electricity_Problem” that has influence on a “computer_problem”. If an external instance of “printer_error” arrives at the situation manager, it generates a dependent instance of “electricity_problem” and a secondary influenced instance of “computer_problem”. This produces a ‘second class’ of influenced instances. The user might want to identify such cases (it can help in impact analysis for example).

CROSS SECTION, GENERALIZED, INFLUENCED, and DEPENDENT are reference events that are created by the situation manager as a result of reference connections.

creator—a built-in string attribute that stores the external event that causes the creation of the instance. It has a null value in the case of a basic (external) event or situation.

influenceOn—a built-in string attribute that stores all the events that were influenced by this event. The information is reported as a string. A name, connection distance and certainty data is reported for each influenced event. In a preferred embodiment the name was 10 characters long, the connection distance 3 characters long and the certainty 5 characters long.

dependsOn—a built-in string attribute that stores all the events that are dependent on this event. The information is reported as a string. A name, connection distance and certainty data is reported for each dependent event. In a preferred embodiment the name was again 10 characters long, the connection distance 3 characters long and the certainty 5 characters long.

certainty—a built-in number attribute that stores the computed certainty of this event. A basic (external) or situation event has a certainty value equal to 1, an influenced/dependent/generalized/crossSection event has a certainty value based on the event model connection certainties.

The above built-in attributes can be used in an expression in the same manner as user-defined attributes.

Impact on Run-Time Performance of Reactive Systems

An efficient algorithm handling the incoming events according to the event model (and according to rules-situations definition) reduces the run-time performance of such systems.

The algorithm specifies the handling of an incoming event's instance according to the generalization/cross-section association/influence on/depends on events' relationships (in the first phase of the algorithm) and how to manage the relevant accepted events according to their contexts/situations (in the second phase of the algorithm).

The algorithm employs the conditions and certainties attributes as part of the regular creation of the set of handling the events (“Events_handling_set”) and the detection of the situations.

On run-time the basic original incoming event can create a set of implied events according to the event model. Each implied event that is created in this process gets a connection-reference attribute expressing its type. For example if the basic original event “mini-car accident” implies (by generalization) the event “car accident”, the event “car accident” gets the connection-reference attribute—“generalized”.

The algorithm handles the case of heterogeneous path from the basic event to the discussed event (example: if the event “mini-car accident” is generalized to “car-accident”, and the event “car accident” can influence the event “the car driver is late for work”, what is the reference type of this event (“the car driver is late for work”).

The algorithm also handles the case of multiple implication to an event (from more than one path from the original event).

In order to demonstrate use of the method according to the invention and to indicate its efficiency in comparison to a typical known approach, there will now be described an example of a system that monitors stock exchange market activity. The system gets events reporting on “buy” or “sell” transactions. These transactions can belong to an independent customer, a customer that represents an organization or directly from the organization itself. A customer activity can be reported directly from a customer, or by an agent that represents it.

The Basic Events:

The following Table shows a list of all the incoming events (i.e. events that arrive from event sources to the monitoring system).

TABLE I
incoming events

| The Event | Arguments | Explanations |
|---|---|---|
| Trade_Start | Time | Time of the trading |
| | | session start |
| Trade_End | Time | Time of the trading |
| | | session end |
| Buy from | Customer | A customer places a |
| customer | Organization | “buy” order for a stock |
| (may belong to an | Stock | |
| organization) | Quantity | |
| Sell from | Customer | A customer places a |
| customer | Organization | “sell” order for a stock |
| (may belong to an | Stock | |
| organization) | Quantity | |
| Buy from | Organization | An organization places a |
| Organization | Stock | “buy” order for a stock |
| | Quantity | |
| Sell from | Organization | An organization places a |
| Organization | Stock | “sell” order for a stock |
| | Quantity | |
| Sell from | Customer | A customer's agent |
| customer's agent | Organization | places a “sell” order for |
| | Activity | a stock |
| | Quantity | |
| Buy from | Customer | A customer's agent |
| customer's Agent | Organization | places a “buy” order for |
| | Activity | a stock |
| | Quantity | |

The Required Situations:

The situations that the system needs to identify are as follows:

1. Heavy_Organization_Activity—At least n activities events by the same organization within the same day, such that the quantity of each activity is greater than 100,000

2. Speculative_Organization—For an organization, there are at least n situations of “sell” after “buy” of the same stock, within the same day.

Remarks:

1. All the situations are evaluated in a lifespan of a trade day. A trading day is figured by Trade_Start, and Trade_End events.

2. In this example, n is set to 3, for all the relevant situations. Of course, it can be set to different thresholds for different situations.

It should be noted that if a customer belongs to an organization, then its activity (directly or by an agent) is considered to be an organization activity.

### Implementation of the System Using known Constructs

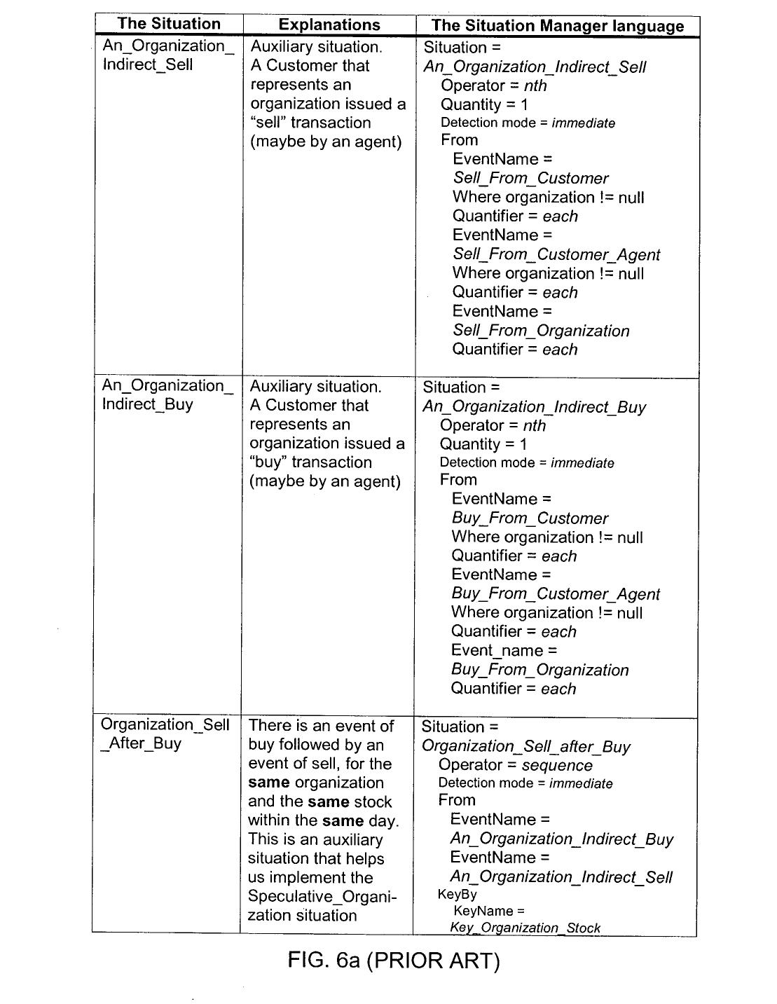

When implementing the required functionality without using an event model, the knowledge that is represented by the event model, needs to be represented by situations. FIGS. 6a and 6b show a possible implementation for doing this.

Thus, as shown in FIGS. 6a and 6b there are defined two auxiliary situations called respectively An_Organization_Indirect_Sell and An_Organization_Indirect_Buy. The “indirect sell” event occurs when a Customer that represents an organization issues a “sell” transaction (maybe by an agent). The “buy” event occurs when a Customer that represents an organization issues a “buy” transaction (maybe by an agent). Possible definitions of these situations using known constructs are shown in the third column of the table.

### Implementation of the System According to the Invention

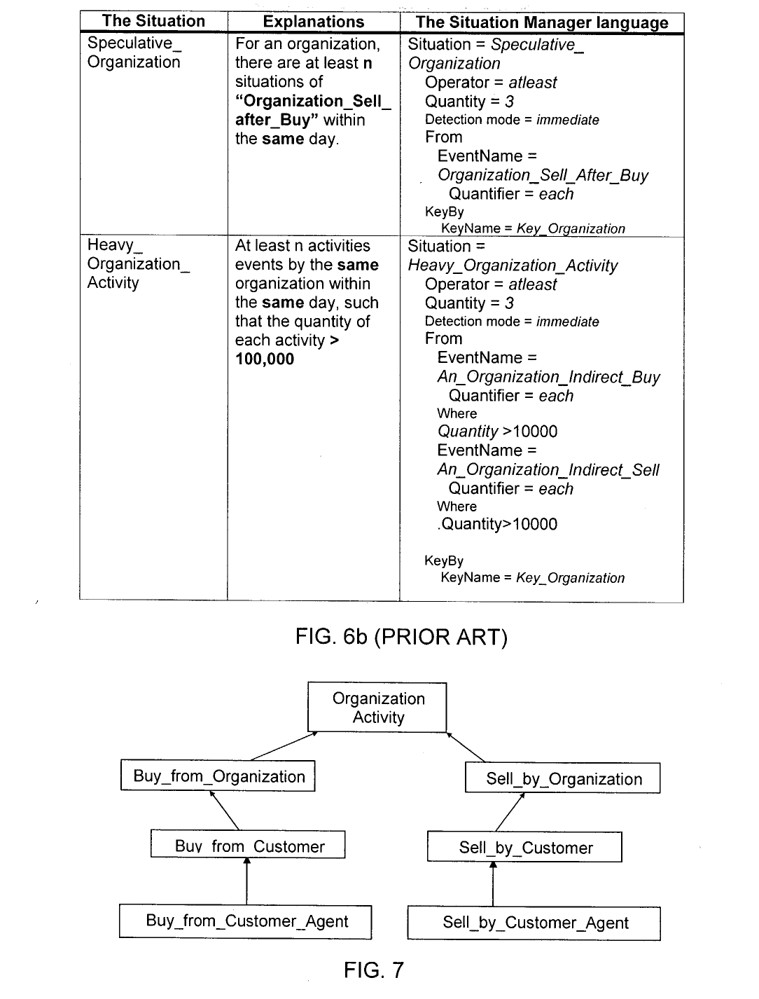

In order to implement the required functionality in accordance with the invention, the connections between the event's classes must first be modeled using the event model described above with reference to FIGS. 1 and 2 of the drawings. FIG. 7 shows the resulting event model depicted all events relating to organization activity. It is to be noted that this diagram does not relate to “buy” and “sell” events that are enacted on behalf of a private customer who does not represent an organization because such events are not relevant to the determination of the activities that are to be monitored by the system.

It will also be noted that the event model shown in FIG. 7 includes a new event “Organization_Activity” that helps in modeling the incoming events, and is defined in the following table.

TABLE II
Definition of new event

| The Event | Arguments | Explanations |
|---|---|---|
| Organization_Activity | Organization | An organization activity |
| | Activity | was registered |
| | Quantity | |

All the connections of the event model shown in FIG. 7 are of type ‘generalization’. For example, a “Buy_from_Customer_Agent” event is generalized to Buy_from_Customer”, saving the particular customer information and ignoring the particular agent that placed the order. In other cases relating to purchasing events there is a subset hierarchy among the events. For instance, the “Buy_from_Customer” event is generalized to “Buy_from_Organization” event only in the case that a customer belongs to organization. The same applies to the selling events.

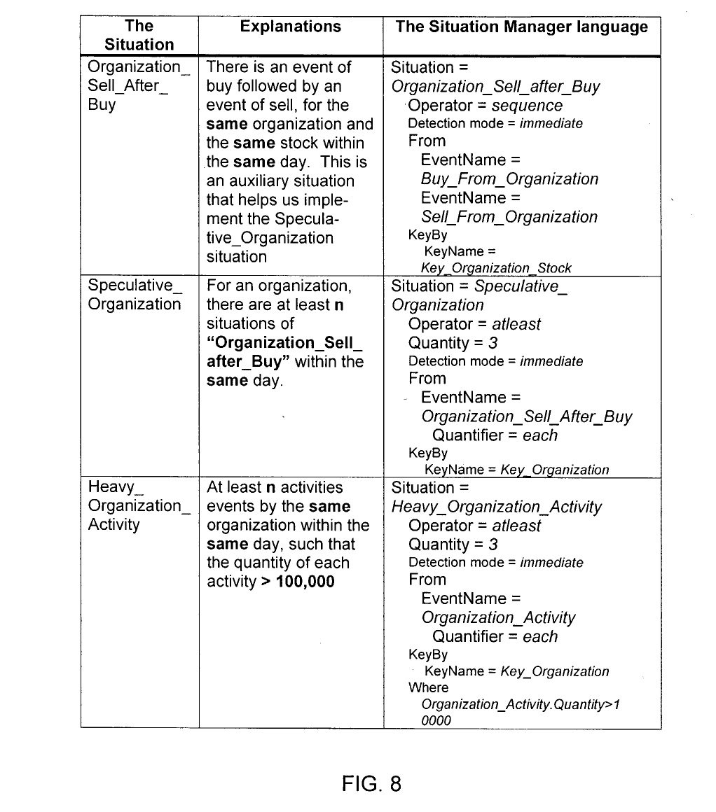

FIG. 8 is a table showing a possible implementation for defining the situations using the event model of FIG. 7. Of the three situations shown in the table, two are reported, and one is an auxiliary internal situation. Thus, FIG. 8 shows that there are only three situations of interest called respectively “Organization_Sell_After_Buy”, “Speculative_Organization” and “Heavy_Organization_Activity”. The meaning of each of these situations is shown in the second column of the table. The third column shows possible definitions of the three situations based on the events in the event model.

Implementing the same requirements, with and without an event model, demonstrates the advantages of using event model, which can be summarized thus:

1. Modeling

The event model allows the system designer to separate the knowledge about the events from the situations' definition. This allows a clear event diagram to be defined that illustrates the event connections, instead of concealing this knowledge inside the situations' definition.

2. Situation definitions

By using the event model there is no need to implement the event connections using situations. This reduces the number of the defined situations and simplifies the situations themselves.

3. Run Time

The number of the defined situations has great influence on the application run-time. Without the event model, even in this small example, two auxiliary situations are needed. This implies high overhead when processsing each incoming event, allowing the system to handle lower rate of incoming events.

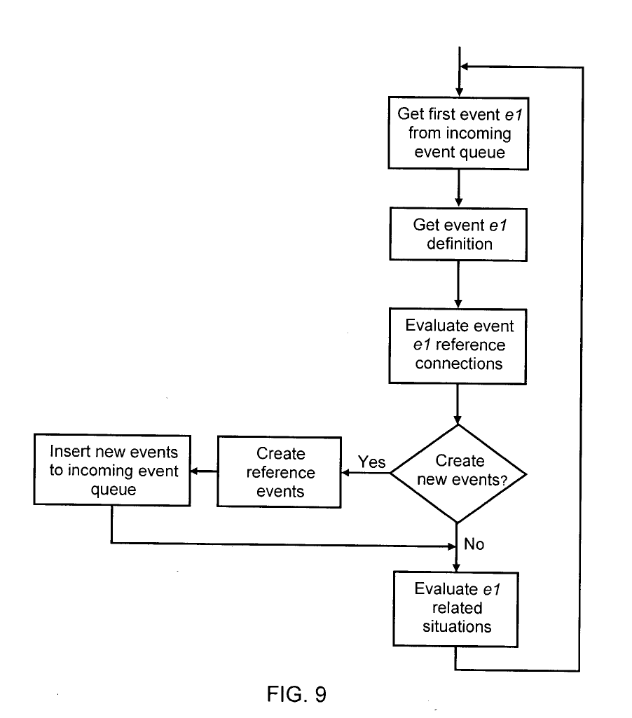

FIG. 9 is a flow diagram showing the principal operations carried out by a situation manager according to the invention. The first event e1 is extracted from the event queue and processed to derive its definition. The reference connections for the event e1 are evaluated. This may require that new (lower order) events be created; if so, the new events are created and added to the event queue for further processing.

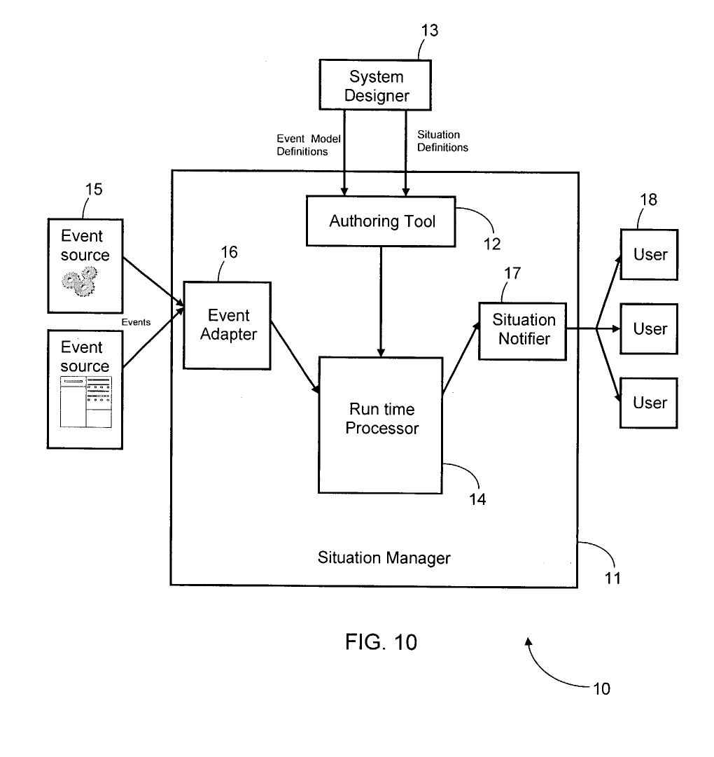

FIG. 10 is a block diagram showing functionally a system 10 carrying out the invention. The heart of the system 10 is a situation manager 11 comprising an authoring tool 12, which serves as an interface for accepting as input event model definitions and situation definitions formulated by a system designer 13. The authoring tool 12 checks the integrity of these definitions and, if they are valid, feeds them to a run time processor 14, which also receives as input one or more events derived from respective event sources 15 via an event adapter 16. The event adapter 16 identifies the occurrence of an event, checks that it is valid and, if so, passes it to the run time processor 14. The run time processor 14 processes the incoming events, the event model and the situation definitions as explained above with reference to FIG. 9 to detect the occurrence of situations based on the incoming events. A situation notifier 17 is coupled to the run time processor for notifying occurrence of specified situations to users 18. Different users may, of course, require to be notified of different situations and the situation notifier 17 may therefore be adapted to filter the situations so as to route the requisite notification to the relevant users. Alternatively, the filtering is optional and all detected situations are notified to all the users.

It will be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Likewise it will be understood that the invention also contemplates a computer-readable data carrier bearing a data structure according to the invention.

In the method claims that follow, alphabetic characters and Roman numerals used to designate claim steps are provided for convenience only and do not imply any particular order of performing the steps.

1. A data structure depicting events for use in a computer implemented situation manager, said data structure comprising an event model defining a hierarchy of events and inter-relationships between events in said hierarchy so as to allow a lower order event to be defined from a higher order event having similar characteristics.

2. The data structure according to claim 1, including data defining an event class and a unique event class such that events having similar characteristics are assigned a common event class have and such that events having identical characteristics are assigned a common unique event class.

3. The data structure according to claim 2, including data defining a subset hierarchy relationship between two event classes, denoting that one or more event classes is a generalization of a specified event class.

4. The data structure according to claim 3, wherein the generalization is a conditional generalization that is contingent upon additional conditions, which can be attribute values and context variables.

5. The data structure according to claim 4, wherein the generalization is implemented by a generalization function generalized-to (E, {E1 . . . , En}) denoting that each of the elements in a set {E1, . . . , En} is a generalization of E and said generalization function accepts as input parameters said attribute values and context variables.

6. The data structure according to claim 2, including data defining an association relationship between two classes and a conditional expression, implemented by a cross-section function Cross-section association-of (E, E′, COND) whereby E′ is a cross-section association of E, under a condition COND.

7. The data structure according to claim 5, wherein the generalization function is assigned a certainty value designating a strength of the generalization.

8. The data structure according to claim 6, wherein the cross-section function is assigned a certainty value designating a strength of the association.

9. A computer-implemented method for establishing a situation using a data structure defining a hierarchy of events and inter-relationships between events in said hierarchy so as to allow a lower order event to be defined from a higher order event having similar characteristics, said method comprising:
(a) pre-configuring before runtime an event model defining an inter-relationship between events that may participate in said situation under defined conditions,
(b) pre-defining before runtime one or more situations that may occur depending on an occurrence of one or more events in the event model and depending on predetermined conditions,
(c) determining on runtime, according to an incoming event and its event definition, all the reference events that need to be generated, and
(d) generating on runtime from the incoming events, the referenced events and conditions all situations that occur.

10. The method according to claim 9, including embedding in the data structure data defining an event class and a unique event class such that events having similar characteristics are assigned a common event class have and such that events having identical characteristics are assigned a common unique event class.

11. The method according to claim 10, including embedding in the data structure data defining a subset hierarchy relationship between two event classes, denoting that one or more event classes is a generalization of a specified event class.

12. The method according to claim 11, wherein the generalization is a conditional generalization that is contingent upon additional conditions, which can be attribute values and context variables.

13. The method according to claim 12, including implementing the generalization by a generalization function generalized-to (E, {E1 . . . ,En}) denoting that each of the elements in a set {E1, . . . ,En} is a generalization of E and said generalization function accepts as input parameters said attribute values and context variables.

14. The method according to claim 9, including embedding in the data structure data defining an association relationship between two classes and a conditional expression, implemented by a cross-section function Cross-section association-of (E, E′, COND) whereby E′ is a cross-section association of E, under a condition COND.

15. The method according to claim 13, including assigning to the generalization function a certainty value designating a strength of the generalization.

16. The method according to claim 14, including assigning to the cross-section function a certainty value designating a strength of the association.

17. A computer-implemented program storage device readable by machine, tangibly embodying a program of instructions executable by the machine to perform method steps for establishing a situation using a data structure defining a hierarchy of events and inter-relationships between events in said hierarchy so as to allow a lower order event to be defined from a higher order event having similar characteristics, said method comprising:
(a) processing an incoming event and an event model defining an inter-relationship between events that may participate in said situation under defined conditions, so as to determine all reference events that need to be generated, and
(b) processing the incoming events, the reference events and conditions so as to generate all situations that occur.

18. A computer-implemented computer program product comprising a computer useable medium having computer readable program code embodied therein for establishing a situation using a data structure defining a hierarchy of events and inter-relationships between events in said hierarchy so as to allow a lower order event to be defined from a higher order event having similar characteristics, said computer program product comprising:
computer readable program code for causing the computer to process an incoming event and an event model-defining an inter-relationship between events that may participate in said situation under defined conditions, so as to determine all reference events that need to be generated, and
computer readable program code for causing the computer to process the incoming events, the reference events and conditions so as to generate all situations that occur.

19. A system for establishing one or more situations based on an occurrence of one or more events, said system having a situation manager comprising:
an authoring tool responsive to event model definitions and situation definitions for checking an integrity of said event model definitions and situation definitions,
an event adapter coupled to one or more event sources for identifying an occurrence of an event and checking that it is valid,
a run time processor coupled to the event adapter for receiving therefrom one or more valid events for processing said events, the event model definitions and the situation definitions so as to detect the occurrence of situations based on the incoming events, and
a situation notifier coupled to the run time processor for notifying occurrence of specified situations.

20. A data carrier bearing thereon a computer readable data structure depicting events for use in a computer implemented situation manager, said data structure comprising an event model defining a hierarchy of events and inter-relationships between events in said hierarchy so as to allow a lower order event to be defined from a higher order event having similar characteristics.
